(19) United States
(12) Patent Application Publication
(10) Pub. No.: US 2002/0169748 A1
(43) Pub. Date: Nov. 14, 2002

(54) Self-updating address book

(76) Inventor: Pavel Macholda, West Linn, OR (US)

Correspondence Address: PAVEL MACHOLDA, 1800 BLANKENSHIP ROAD, SUITE 200, WEST LINN, OR, 97068, US

(21) Appl. No.: 09/853,169

(22) Filed: May 11, 2001

(51) Int. Cl. G06F 7/00

(52) U.S. Cl. 707/1

(57) ABSTRACT

A Self-updating Address Book consists of two parts: the list of contacts and the profile of its own user. Each user of a Self-updating Address Book either chooses or is assigned a name or a number. Such a name becomes the user's locator. Inside the Self-updating Address Book, the contact list consists solely of a set of locators, which the user adds or deletes in lieu of the actual contact information. In the profile area, the user maintains his/her own contact information, such as name, phone number, address, etc. When the user wants to view or otherwise retrieve the contact information of someone on his/her list, the Self-updating Address Book uses the locator to find the original profile of the other user and instantly deliver that information.

### CROSS-REFERENCE TO RELATED APPLICATIONS

None

### STATEMENT REGARDING FED SPONSORED R&D

Neither the invention, nor any part of it, was made under federally sponsored research and development

### REFERENCE TO SEQUENCE LISTING

None

### BACKGROUND OF THE INVENTION

1. Field of the Invention

The invention relates to the field of applications for communication devices capable of storing and processing information in a digital form, such as cellular phones, wireless personal digital assistants, network appliances and computers. The closest U.S. patent Classification Definition is described in Class 707, Subclass 104—application of distributed data structure to commercial fields.

2. Background Information

More and more people embrace communication technologies based on digital protocols, such as digital cell phones, wireless personal digital assistants, and the Internet. The proliferation of service providers makes it easy to switch from one phone company to another, or to choose a more competitive Internet provider. Often, such a switch results in a new phone number or a new e-mail address. As people often keep the obsolete phone numbers in their address books (and frequently pass them on to mutual friends) the resulting chaos may be difficult to sort out, and, consequently, people often dial disconnected phone numbers, send e-mails to non-existent addresses, and thus sometimes lose old friends.

The present methods of safekeeping contact information have two major shortcomings. First, the person whom the information concerns is not in control of that information. For example, once person A gives his new phone number to person B, it is up to person B to store that information somewhere and erase the old phone number. Often, person B either does not erase the old phone number, or enters the new phone number in a different place. Later, person B might forget which phone number is which and give the old phone number to person C—at this stage, person A does not even know that person C received the old phone number. Second, a person who changes, for example, an e-mail address, must notify his friends of the change. As is often the case, some people on the list have already a different e-mail address and thus, the person cannot notify them of his change. Consequently, the contact between the two people may be lost.

The self-updating address book invention changes the way the contact information is managed. First, the invention returns the control of the contact information back to the person who is most qualified to be in charge of that information: the person whom the information is about. Second, the invention assures that there is no obsolete contact information left within the system immediately after the person changes something in his profile, for example, his e-mail address. The invention achieves these innovations by keeping the contact information in only one place, in the device of the concerned user, where he can easily modify it at any time, and from where the others, for example, his friends, can easily retrieve that information each time they need to look it up, dial the phone number, or address an e-mail. Thus, the friends always see the latest information.

### BRIEF SUMMARY OF THE INVENTION

A Self-updating Address Book is a method, that is deployed using a digital device capable of storing and processing information, and communicating with similar devices that are also equipped with an applied Self-updating Address Book. A Self-updating Address Book may be a computer software, chip, device, appliance, or any other form capable of deploying the method. Each user of a Self-updating Address Book either chooses or is assigned a name or a number. Such a name becomes the user's locator. From the user's viewpoint, a Self-updating Address Book consists of two parts: the list of contacts and the profile of its own user. Inside the Self-updating Address Book, the contact list consists solely of a set of locators, which the user adds or deletes in lieu of the actual contact information. In the profile area, the user maintains his/her own contact information, such as name, phone number, address, etc.

When the user wants to view or otherwise retrieve the contact information of someone on his/her list, the Self-updating Address Book uses the locator to find the profile in the Address Book of the other user and instantly deliver that information.

### BRIEF DESCRIPTION OF THE DRAWINGS

FIG. 1

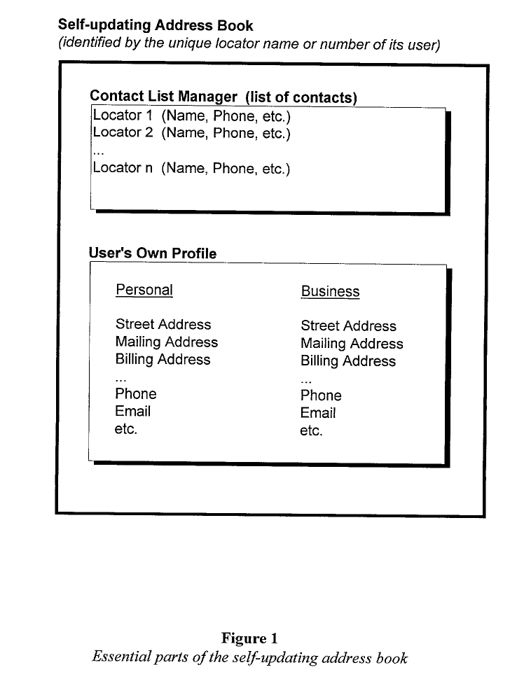

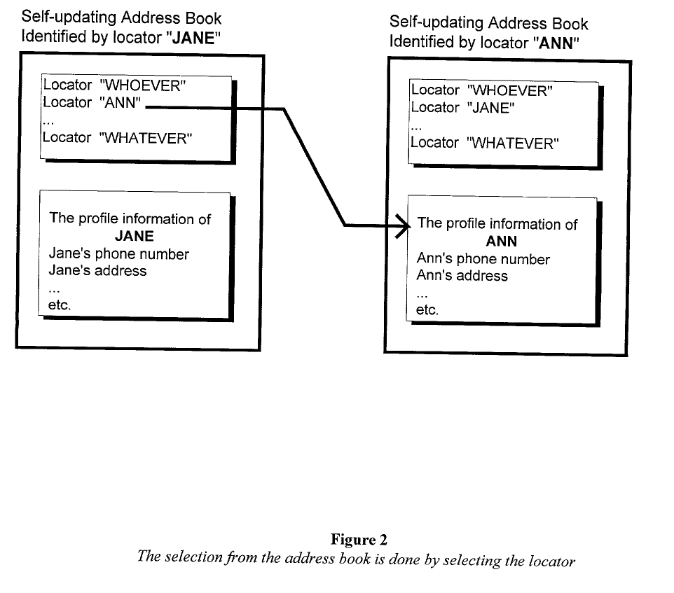

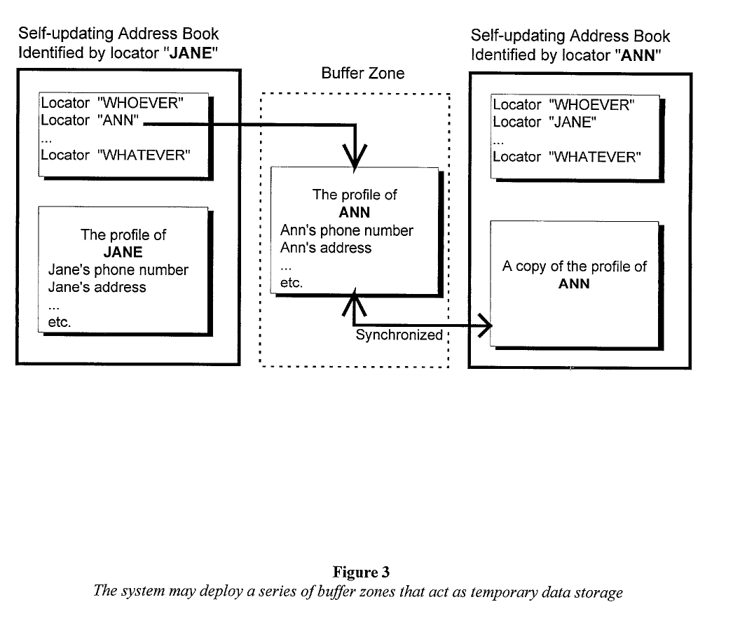

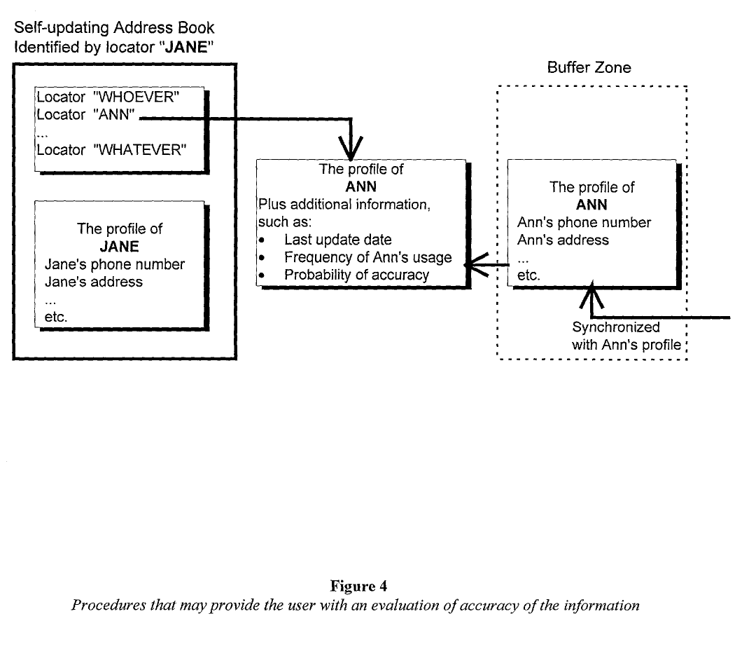

The diagram shows both essential parts of the self-updating address book: The contact list area, which keep the set of locators and allows the user to sort and select from the address book. The sorting is accomplished in two steps: first, the address book obtains the information which it needs for sorting, for example, the last names of the persons; using the locators, the address book retrieves the names directly from the profiles of the concerned persons and stores the information in a temporary memory buffer. Second, the address book sorts the information in the buffer.

The user's profile information area, where the user enters and edits his/her own contact information, such as, phone numbers, e-mail addresses, etc.

FIG. 2

The selection from the address book is done by selecting the locator, for example, by touching the screen above the text, etc. Then, the address book uses the locator to locate the profile of the person, fetch the contact information, and display or otherwise retrieve it for the user. The user may elect to display other information than the actual locator name or number. For example, the contact list may display the actual names of the persons in the contact list. In such a case, the address book keeps a memory buffer holding these names, and refreshes the memory by fetching the names from the actual profiles as often as the communication speed permits.

FIG. 3

In a case the device that holds the user's profile might be temporarily off-line, the Self-updating address book system may deploy a series of buffer zones that act as temporary data storage; if the locator fails to reach the destinations device, the locator may opt to retrieve the contact information from the buffer zone which is the closest to the device being located. If the contact information is not fetched directly from the original device, the locator leaves an instruction in the buffer zone, directing the buffer manager to contact the device at a later time and refresh the content of the buffer zone. There may be several buffer zones between the requesting device and the device that holds the information, in order to assure that at least some type of contact information is made available to the requesting user. Also, the system may inform the requesting user of the fact that the locator has not reached the device and that a backup information is being furnished instead.

FIG. 4

Even though each set of contact information is being managed by the concerned user, the contact information is accurate only providing that the concerned user keeps it up to date. The Self-updating Address Book deploys procedures that provide the user with an evaluation of accuracy of the information. The evaluation is based on the time that elapsed since the concerned user last updated his profile as well as on the frequency at which the concerned user accesses his own Self-updating Address Book to look-up contact information.

### DETAILED DESCRIPTION

1. Terminology

Self-updating Address Book (or simply address book throughout this document) is a method, that is deployed using an electronic device capable of storing and processing information, and communicating with similar devices that are also equipped with an applied Self-updating Address Book. A Self-updating Address Book may be a computer software, chip, device, appliance, or any other form capable of deploying the method.

User or requesting user is a person who uses a Self-updating Address Book to access the contact information of other people.

Concerned user is a person who manages his own contact information using a Self-updating Address Book and who makes such information available to other users.

Locator is a name, number, or a combination of both, that uniquely identify a single user.

2. Description

The key element of the Self-updating Address Book method rests in the procedures applied to maintain the contact information of each concerned user up to date.

First, the methodology removes the power of users to modify the contact information of the concerned user—even within the scope of their own address books, and entrusts only the concerned user with the right to modify his own contact information.

Second, a Self-updating Address Book does not store the contact information, but rather stores the locator, which determines the original location of the contact information. Each time a user accesses the contact information of another user, the Self-updating Address Book fetches the information anew, from the profile of the concerned user, using the locator. Thus, providing that the device that stores the contact information of the concerned user is accessible from the device of the requesting user, the information presented to the requesting user by the Self-updating Address Book is always a true reflection of the information made available by the concerned user himself.

Such a system relies heavily on accessibility of the concerned user's device to repeatedly fetch the concerned user's contact information to the requesting users. Although the speed and power of wireless and on-line electronic devices make such a system fully feasible today, the robustness of the system is greatly improved by storing the concerned user's profile information in buffer zones, or data centers, where such information can be better protected. That does not change the data transfer model, as the concerned user remains the only person who is allowed to modify his own contact information. In a case of the buffer zone, the concerned user's contact information is downloaded to the concerned user's device each time the concerned user wishes to view or modify the information. As an additional benefit arising from using the buffer zone, the concerned user may modify his contact information from any device, after the buffer zone verifies the user's identity, for example, through the locator name or number, and a password. In such a case, the concerned user may gain access to his contact information from any device, such as, a cell-phone, personal digital assistant, or an Internet terminal. Although, in a practical application, the place where the original information is kept may not be the concerned user's device, or the information may be kept in more than one place and synchronized using the date and time of the modification, such a fact does not change the basic premises of the invention, that is—the concerned user is the only person who is in charge of his own contact information. The contact list of each user is assembled by the user by adding the locator names or numbers to his address book. At the time a locator is added to an address book, the system fetches the last name, first name, etc. of the concerned person from his profile and stores the names in the memory of the device. The user may elect to view the names in lieu of the locator names in order to easily navigate through the address book. The address book periodically refreshes the list of names to assure the names in the memory coincide with the names in the profiles of the users defined by the locators.

If the user elects to view more information at the same time as he browses through the address book, for example, the name together with a phone number (as is displayed in most cellular phones today), the system keeps the most recent information in the memory of the device and, while the user pauses before scrolling to the next item, the device dispatches a request to update the information. The new information arrives directly from the profile of the concerned user and the device replaces the old information in the memory of the device with the new information if the two pieces of information do not match. The address book notifies the user that a difference has been detected and that an update took place.

Periodically, the address book stores its contents into the buffer zone. First, the user may view the address book from a variety of devices, for example, from a cell-phone and from a personal digital assistant, and may add or delete from the list using any device. Second, the user is able to restore completely the address book's contents in a case of malfunction, misappropriation, theft, or replacement of the device.

The actual place where the user's list of locators and the partial data that represent the contact list are kept may vary or the list may be kept in a more than one place and continually synchronized using dates and times of the modifications. That does not affect the basic premises of the Self-updating Address Book method which rests in the fact that the locators, not the actual contact information, form the basis of the address book's contact list.

What is claimed is:

1. A contact list manager (address book), where each entry in the list is represented by a locator, which enables the user to locate the original location, where the user whose information is being requested stores and is able to modify his own contact information.

2. A user profile management system, where each profile is maintained by the concerned user who is identified to the system by a unique locator name or number, and the profiles are made available to those other users who include the concerned person's locator in their contact list managers (address books).

3. The contact list managers and user profile managers set forth in claims 1. and 2. which further include functions for storing, retrieving, deleting, modifying, and communicating the lists of locators and the profile information using the functions set forth in claims 1. and 2.

4. The contact list managers and user profile managers set forth in claims 1. and 2. which further include functions for wireless and communication-line based electronic devices to transfer, retrieve, modify, delete, and communicate the information contained in the lists of locators and the profile information of the users of the system.

5. The contact list managers and user profile managers set forth in claims 1. and 2. which further include functions for utilizing data storage centers (buffer zones) to synchronize and safeguard the information contained in the lists of locators and the profile information of the users of the system.
